(19) United States
(12) Patent Application Publication
(10) Pub. No.: US 2023/0258854 A1
(43) Pub. Date: Aug. 17, 2023

(54) AN ILLUMINATED STRAP ASSEMBLY AND A METHOD FOR ILLUMINATING A STRAP STRUCTURE

(71) Applicant: MEDINOA OY, Espoo (FI)

(72) Inventors: Markku ERÄLUOTO, Espoo (FI); Hanna KUUSISTO, Espoo (FI)

(21) Appl. No.: 18/011,555

(22) PCT Filed: Jun. 21, 2021
(86) PCT No.: PCT/FI2021/050469

§ 371 Date: Dec. 20, 2022

(30) Foreign Application Priority Data
Jun. 22, 2020 (FI) 20205649

(51) Int. Cl. F21V 8/00; F21L 4/08; F21V 33/00; A01K 27/00

(52) U.S. Cl. CPC G02B 6/001; A01K 27/004; A01K 27/006; F21L 4/08; F21V 33/0004

(57) ABSTRACT

An illuminated strap assembly and a method for illuminating a strap assembly. The assembly includes a housing, a rotatable strap spool connected rotatably to the housing, a light emitting strap structure arranged to and fixed to the rotatable strap spool. The assembly includes a light source arranged to radiate light towards the rotatable strap spool and to illuminate the light emitting strap structure arranged to the rotatable strap spool.

### FIELD OF THE INVENTION

The present invention relates to an illuminated strap assembly and more particularly to an illuminated strap assembly according to preamble of claim 1. The present invention further relates to a method for illuminating a strap structure according to preamble of claim 15.

### BACKGROUND OF THE INVENTION

In the prior art it is known an illuminated pet leash where the light source comprises a strip of electroluminescent material. An electroluminescent wire is a thin copper wire coated in a phosphor. Light is produced through electroluminescence when an alternating current provided by a conventional DC battery and an inverter is applied to it.

One of the problems associated with the prior art is that the electroluminescent wire is not flexible enough to be moved smoothly in the spooling device during winding and unwinding. Further, the electroluminescent wire contains a copper wire inside. Each time the copper wire bends or flexes it is stressed. Copper has poor resistance to repeated stressing, even if the stress is kept low. Copper also has very low resistance to shear stress and it will deform.

In the prior art is also known a pet leash such which reflects light pointed to the leash. This kind of leash is not illuminated all the time.

Therefore, there is a need for an illuminated strap assembly which is all the time visible even in poor illumination conditions, is wear-resistant and is reliable to use.

### BRIEF DESCRIPTION OF THE INVENTION

An object of the present invention is to provide an illuminated strap assembly and a method for illuminating a strap structure so as to overcome or at least alleviate the prior art disadvantages.

The objects of the invention are achieved by an illuminated retractable strap assembly which is characterized by what is stated in the independent claim 1. The objects of the invention are further achieved by a method for illuminating a strap structure which is characterized by what is stated in the independent claim 15.

The preferred embodiments of the invention are disclosed in the dependent claims.

The invention is based on the idea of an illuminated strap assembly, the assembly comprising a housing, a rotatable strap spool connected rotatably to the housing, a light emitting strap structure arranged to and fixed to the rotatable strap spool. The light emitting strap structure comprising a first end and a second end. The assembly further comprises a light source connected to the housing. The light source is arranged to radiate light towards the rotatable strap spool and to illuminate the first end of the light emitting strap structure arranged to the rotatable strap spool.

In an embodiment of the invention, the strap structure comprises one or more elongated optical fibers having a first end and a second end for transmitting light between the first end and the second end, and an outer covering. The elongated optical fiber comprises a side emitting optical fiber or a side glow optical fiber. In a side emitting fiber the light gradually escapes along the whole length of the fiber through a cladding surrounding the optical fiber core. The outer covering is arranged to pass at least part of the light originating from the one or more elongated optical fibers to be transmitted through.

This reduces longitudinal stresses the one or more elongated optical fibers are subjected.

In an embodiment of the invention, the assembly comprises a light receiving face arranged to the rotatable strap spool, the light receiving face is arranged to face towards the light source, and the light source is arranged to radiate light onto the light receiving face.

In an embodiment of the invention, the light source is directed towards the light receiving face.

In an embodiment of the invention, the assembly comprises an optic rotary connector for transmitting light from the housing to the rotatable strap spool.

In an embodiment of the invention, the optic rotary connector is arranged between the light source and the light receiving face.

In one embodiment of the invention, the optic rotary connector comprises fiber optic slip rings having a stator side and a rotor side.

In an embodiment of the invention, optical fibers are arranged between the light source and the optic rotary connector.

This enables illuminating the light emitting strap structure fixed the rotatable strap spool with radiating light. In other words there is no need to conduct electricity to the rotatable strap spool and thus this increases reliability of the assembly.

In an embodiment of the invention, the first end of the one or more elongated optical fibers comprises the light receiving face.

This reduces number of components of the assembly.

In an alternative embodiment of the invention, the assembly comprises a light transmitting arrangement having a first end and a second end, the light transmitting arrangement is connected to the rotatable strap spool, the first end of the light transmitting arrangement comprises the light receiving face, and the second end of the light transmitting arrangement illuminates the first end of the one or more elongated optical fibers.

This eases an installation of the assembly.

In one embodiment the light transmitting arrangement is an optical fibre.

This eases manufacturing of the assembly.

In an alternative embodiment the rotatable strap spool comprises light transmitting material and the light transmitting arrangement is a reflective material arranged inside the rotatable strap spool.

This further eases manufacturing of the assembly.

In a yet alternative embodiment the light transmitting element comprises air and a light reflective material.

In one embodiment of the invention, the light transmitting element comprises a light reflective hollow form and air inside the light reflective hollow form. This further eases manufacturing of the assembly.

In an embodiment of the invention the assembly comprises a retraction mechanism for retracting the strap structure around the rotatable strap spool.

This eases winding the strap structure around the rotatable strap spool.

In an embodiment of the invention the rotatable strap spool comprises a first spool part and a second spool part attached to the first spool part, the retraction mechanism is arranged between the first spool part and the second spool part.

This further eases an installation of the assembly.

In an alternative embodiment of the invention, the retraction mechanism is arranged between the rotatable strap spool and the housing,

This further eases an installation of the assembly

In an embodiment of the invention, the retraction mechanism is fixed to the first spool part and to the housing.

This further eases an installation of the assembly.

In an embodiment of the invention, the second spool part is arranged to have a same shape with the first spool part.

This reduces number of different components of the assembly.

In an embodiment of the invention, the first spool part and the second spool part are arranged to have a rotatable connector for joining the first spool part and the second spool part together.

In an embodiment of the invention the first spool part comprises a strap space for receiving the strap structure. The light transmitting arrangement is connected to the second spool part and the first spool part comprises a light transmitting arrangement opening. The light transmitting arrangement extends via the light transmitting arrangement opening to the strap space.

This eases an installation of the assembly.

In an alternative embodiment of the invention the first spool part comprises a strap space for receiving the strap structure. The light transmitting arrangement is connected to the first spool part and the first spool part comprises a light transmitting arrangement opening. The transmitting element extends via the light transmitting arrangement opening to the strap space.

This eases an installation of the assembly.

In an alternative embodiment of the invention, the second spool part and first spool part comprise the light transmitting arrangement opening, and the light transmitting arrangement extends between the second spool part and first spool part via the light transmitting arrangement opening to the strap space.

In an embodiment of the invention the assembly comprises a first lens. The first lens is arranged between the light source and the light receiving face to focus light from light source onto the light receiving face.

This increases illumination of the strap.

In an embodiment of the invention the rotatable strap spool having a centre of rotation. The light receiving face is arranged to the centre of rotation of the rotatable strap spool.

This increases illumination of the strap.

In an alternative embodiment of the invention the rotatable strap spool having a centre of rotation. The light receiving face is arranged to the rotatable strap spool at a distance from the centre of rotation of the rotatable strap spool.

This eases an installation of the assembly.

In an embodiment of the invention the assembly comprises two or more the light sources connected to the housing at the distance from the centre of rotation of the rotatable strap spool.

This increases illumination of the strap.

In an embodiment of the invention the light source comprises a light-emitting diode or a laser diode.

The power consumption of a light-emitting diode or a laser diode is low.

The light source may provide a blinking light or a steady light. Further, the light source may comprise a multicolor light-emitting diode

In an embodiment of the invention the assembly comprises a power source electrically connected to the light source, and the power source is connected to the housing.

This further increases reliability of the assembly.

In an embodiment of the invention the assembly the power source comprises a rechargeable power source, the rechargeable power source comprises a charging port, and electronics for charging. The charging port and electronics are connected to the housing.

This avoids need for changing batteries.

In an embodiment of the invention the assembly comprises a connector arranged to the second end of the light emitting strap structure.

The connector enables attaching a pet collar or a pet harness to the illuminated strap.

In an embodiment of the invention the housing comprises a grip portion and a support portion for the strap spool. The strap spool is positioned within the support portion and the strap spool is rotatably supported on the support portion.

This increases usability of the assembly.

In one embodiment of the invention the assembly comprises two or more optical fibers.

The advantage of providing two or more elongated optical fibers, e.g. a bundle of optical fibers is that if a single optical fiber is damaged the other optical fibers still provide illumination to the strap.

In an embodiment of the invention the illuminated retractable strap assembly may comprise the outer covering fixed to the strap spool and to the connector. The first end of the one or more elongated optical fibers can then be fixed only to the strap spool. This reduces longitudinal stresses the one or more elongated optical fibers is subjected. Further, the length of the one or more elongated optical fibers can be different than the length of the outer covering.

In an embodiment of the invention the first end of the outer covering is fixed to the strap space and the first end of the one or more elongated optical fibers extend to the light receiving face.

In an embodiment the retraction mechanism comprises a spring biased element, for instance, capable of automatically winding the strap structure to the strap spool.

In an embodiment of the invention the one or more elongated optical fibers may comprise an outer surface provided with areas opaque to light. The opaque areas may be arranged at intervals proving a striped illumination, for instance. The areas opaque to light reduce the power required from the light source to illuminate the strap.

In an embodiment of the invention the illuminated retractable strap assembly may comprise the strap structure comprising elongated flexible strengthening fibers.

The elongated flexible strengthening fibers may be arranged to surround the one or more elongated optical fibers, or the elongated flexible strengthening fibers and the one or more elongated optical fibers may be arranged to form a bundle. The strengthening fibers provide tensile strength to the strap structure. Tensile strength is defined as the resistance to longitudinal stresses or pull. The elongated flexible strengthening fibers are bendable but they stretch in the length direction only to a limited extent. The elongated flexible strengthening fiber stretches less in the length direction than the elongated optical fiber. Further, the strengthening fibers protect the one or more elongated optical fibers against damage and from been crushed.

Further, the elongated flexible strengthening fibers may be fixed to the strap spool and to the connector. The first end of the one or more elongated optical fibers can then be fixed only to the strap spool. This reduces longitudinal stresses the one or more elongated optical fibers is subjected. Additionally, the length of the one or more elongated optical fibers may be different than the length of the elongated flexible strengthening fibers.

In an embodiment of the invention the first end part of the strap structure comprises an indication that the first end of the strap structure is in vicinity. The indication may comprise a colour in the outer covering, the outer covering blocks the transmission of light originating from the one or more elongated optical fibers or a cladding of the one or more elongated optical fibers blocks the transmission of light originating from the one or more elongated optical fibers.

In an embodiment of the invention the illuminated retractable strap assembly comprises a position detector for measuring an amount of the illuminated retractable strap in the strap spool and changing a colour of the light source when the strap spool comprises a predefined amount of the illuminated retractable strap. In other words the colour of the light source changes to indicate that almost all the illuminated retractable strap is unwound. This improves control of a position of the connector.

In an embodiment of the invention the illuminated retractable strap assembly comprises a position detector for measuring an amount of the illuminated retractable strap in the strap spool, detecting rotation direction of the strap spool and changing a colour of the light source.

In other words the light source has a different colour during unwinding, winding and when the illuminated retractable strap is not moving. In an alternative embodiment of the invention the light source has a different colour during unwinding and winding. This further improves control of a position of the connector. For instance, the position detector may comprise an electrical or optical or mechanical device for measuring an amount of the illuminated retractable strap in the strap spool and for measuring the rotation speed and direction of the strap spool. In an embodiment of the invention the assembly may comprise a reflector arranged in connection to the first or the second end of the one or more elongated optical fibers where the other of the first and the second ends comprises the light source, or the first or the second end of the one or more elongated optical fibers comprises a reflecting layer where the other of the first and the second ends comprises the light source. The reflective layer may comprise a polished metal surface or a coating comprising a metal coating or a dielectric reflecting coating.

In an embodiment of the invention the assembly may comprise two light sources. Then the first light source is arranged to illuminate the first end of the one or more elongated optical fibers and the second light source is arranged to illuminate the second end of the one or more elongated optical fibers. The power source may be common to both light sources, where the supply line to the other light source runs in the strap structure, or each light source may have a separate power source.

In an embodiment of the invention a material of the elongated flexible strengthening fibers may comprise aramid, polyester, polyamide, polyethylene, ultra-high-molecular-weight polyethylene or polypropylene. The strengthening fibers have lightweight and high tensile strength. Tensile strength is defined as the resistance to longitudinal stresses or pull.

In an embodiment of the invention the outer covering may be transparent, translucent and/or it may comprise a braided structure. The outer covering may comprise reflective material or comprise a reflective surface to further intensify the illumination. The outer covering may comprise elongated strands.

The outer covering may comprise a fiber braided sleeving, for instance, giving protection to the one or more elongated optical fibers. The fiber braided sleeving may be made from continuously woven fiber, and the material may comprise a man-made fibre, a plastic-based material or a polymer-based fiber. In a braided structure, the one or more elongated optical fibers may be woven within the covering.

In an embodiment of the invention a material of the outer covering may comprise aramid, polyester, polyamide, polyethylene, ultra-high-molecular-weight polyethylene or polypropylene.

In an embodiment of the invention the outer covering or the one or more elongated optical fibres comprises a colour material. A colour light is easier to see in dark and thus less power is required to the light source. In a preferable embodiment of the invention the outer covering or the one or more elongated optical fibres comprises a neon colour material. This further decreases required power.

In an embodiment the outer covering and the light source have the same colour, or the one or more elongated optical fibres and the light source have the same colour. This further decreases required power.

In an embodiment of the invention the assembly may comprise the power source, the power source comprising a rechargeable power source. In one embodiment the rechargeable power source comprises a charging port, and electronics for charging. The charging port comprises an USB charging port, for instance.

In an embodiment of the invention the assembly is connected to a mains electricity.

In an alternative embodiment the rechargeable power source comprises a wireless charging component and electronics for charging.. A wireless charging component may be an induction coil, for instance. The wireless charging component and electronics 13 are connected to the housing.

In an embodiment of the invention the assembly may comprise a dynamo arranged in connection to the rotatable strap spool for charging the rechargeable power source. As an example, the dynamo can comprise a dynamo USB charger.

In an embodiment of the invention the strap structure may be a round in cross-section, or the strap structure may be a flat rectangular in cross-section or the strap structure may be an elliptical in cross-section or the strap structure may be a polygonal in cross-section.

In an embodiment the illuminated strap assembly comprises an animal tethering device, e.g. a retractable leash for animals, for instance. The connector in the second end of the strap structure is releasably attachable to a pet collar or to a pet harness. The connector may be a hook or a snap hook, as an example.

In an alternative embodiment the one or more elongated optical fibers extends to a pet collar or to a pet harness. Thus the pet collar or the pet harness are illuminated. The connector in the second end of the strap structure may be a buckle of the pet collar or the pet harness, as an example.

In an embodiment of the invention the one or more elongated optical fibers comprise an optical fiber connector for arranging a releasable connection between the one or more elongated optical fibers in the rectractable leash and the one or more elongated optical fibers in the pet collar or the pet harness.

In an embodiment of the invention the strap opening in the housing may be widening outwards for protecting the strap structure from wear caused by an outer edge of the strap opening. Additionally, or instead, the strap opening may comprise a flexible sleeve part attached to the strap opening and extending outwards from the support portion, for protecting the strap structure from wear caused by an outer edge of the strap opening.

In an embodiment of the invention the assembly may comprise a stop mechanism for stopping a rotation of the strap spool, and the stop mechanism comprises a button provided on the outer surface of the housing.

In an embodiment of the invention the assembly may comprise an automatic twilight switch for turning on and turning off the light source, and/or an automatic motion sensor or a mechanical switch or a proximity sensor for detecting an unwinding and a retraction of the strap structure where the unwinding is turning on and the retraction is turning off the light source. In an embodiment of the invention the illuminated retractable strap assembly comprising a housing may comprise two or more rotatable strap spools each comprising a strap structure with a connector. The housing comprises the support portion for the two or more separate strap spools. The support portion may be a common support portion for the two or more rotatable strap spools, or the support portion may comprise two or more separate support portions. In the housing the two or more strap spools are positioned parallel or are arranged in a stack within the housing. The housing comprises two or more strap openings, one for each strap structure.

The assembly may comprise a housing comprising a grip portion and a support portion for the two or more rotatable strap spools. Then the two or more strap spools are positioned parallel or are arranged in a stack within the support portion of the housing.

In one embodiment of the invention at least a part of the housing is transparent or translucent. Thus the housing allows at least part of the light originating from the one or more elongated optical fibers to be transmitted through. This improves visibility and safety.

The present invention relates also to a method for illuminating a strap structure. The method is carried out with a strap assembly comprising a housing, a rotatable strap spool connected rotatably to the housing, a light emitting strap structure arranged to and fixed to the rotatable strap spool. The assembly further comprises a light source connected to the housing.

The method for illuminating a strap structure comprises radiating light from the light source to the rotatable strap spool to illuminate the first end of the light emitting strap structure arranged to the rotatable strap spool.

The method may be carried out with any previously disclosed illuminated strap assembly.

An advantage of the invention is that the illuminated strap structure is visible even in poor illumination conditions in the surroundings. The invention enables illuminating the strap structure fixed to the rotatable spool without conducting electricity to the rotatable spool. Furthermore, the illuminated strap structure is wear-resistant and the assembly is reliable in a use. Furthermore, the assembly is easy to manufacture.

### BRIEF DESCRIPTION OF THE DRAWINGS

The invention is described in detail by means of specific embodiments with reference to the enclosed drawings, in which

FIGS. 1a, 1b, 2, 3, 4, and 5 show schematically different embodiments of an illuminate strap assembly according to the present invention;

FIG. 6 shows schematically a side view of an illuminated strap assembly comprising a housing with a grip;

FIG. 7 shows schematically an elongated optical fiber;

FIGS. 8a), 8b), 8c) and 8d) show schematically a cross-section of a strap structure; and

FIGS. 9a), 9b) and 9c) show schematically a cross-section of a strap structure.

### DETAILED DESCRIPTION OF THE INVENTION

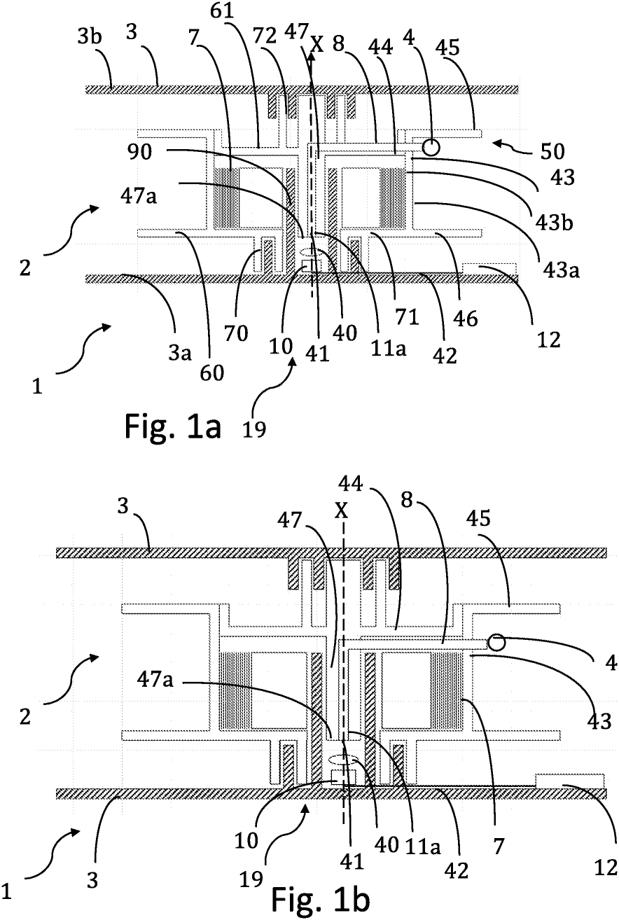

FIG. 1a shows one embodiment of an illuminated strap assembly according to the invention. The assembly 1 comprises a rotatable strap spool 2, a housing 3, a light emitting strap structure 4 comprising a first end 5a and a second end 5b and a light source 10. In the FIG. 1a the rotatable strap spool 2 is arranged inside a housing 3 and supported to the housing 3. The strap spool 2 can also be supported by an axle. The rotatable strap spool 2 is connected rotatably to the housing 3. In other words the strap spool 2 can be rotated around a centre of rotation X. The light emitting strap structure 4 arranged to and fixed to the rotatable strap spool 2. The light source 10 is connected to the housing 3. In other words the light source 10 does not rotate when the rotatable strap spool 2 rotates the light source 10 is arranged to radiate light towards the rotatable strap spool 2 and to illuminate the first end 5a of the light emitting strap structure 4 arranged to the rotatable strap spool 2.

In this embodiment the strap structure 4 comprises one or more elongated optical fibers 8 having a first end 11a and a second end 11b and an outer covering 9. The one more elongated optical fibers 8 transmit light between the first end 11a and the second end 11b. The outer covering 9 allows at least part of the light originating from the one or more elongated optical fibers 8 to be transmitted through.

The assembly 1 comprises a light receiving face 41 arranged to the rotatable strap spool 2, the light receiving face 41 faces towards the light source 10, and the light source 10 is arranged to radiate light onto the light receiving face 41. In other words the light source 10 may touch the light receiving face 41 but the light source 10 is not fixed to the light receiving face 41. This means that the light receiving face 41 rotates when the rotatable strap spool 2 rotates but the light source 10 does not rotate.

In one embodiment, a distance between the light source 10 and the light receiving face 41 is stationary.

Anyhow, it should be noted, that due to mechanical tolerances and clearances between parts, the relative position and distance between the light source 10 and the light receiving face 41 may vary slightly.

In this embodiment the first end 11a of the one or more elongated optical fibers 8 comprises the light receiving face 41. In other words the light source 10 radiates light onto a face of the first end 11a of the one or more elongated optical fibers 8.

The rotatable strap spool 2 comprises a first spool part 60 and a second spool part 61. The first spool part 60 further comprises a first strap guide wall 45, a second strap guide wall 46, a strap bottom wall 43 having a first surface 43a and a second surface 43b, a retraction mechanism wall 71 and a first supporting element 70. The strap bottom wall 43 extends between the first strap guide wall 34 and the second strap guide wall 46. The strap bottom wall 43, the first strap guide wall 45 and a second strap guide wall 46 form a strap space 50 for receiving the strap structure 4. The retraction mechanism wall 71 extends from the strap bottom wall 43 towards the centre of rotation X of the rotatable strap spool 2.

The second spool part 61 further comprises a cover wall 44, a cover axle 47 having a first cover axle end 47a and a second supporting element 72.

The strap structure 4 is arranged on the strap bottom wall 43 between the first strap guide wall 45 and the second strap guide wall 46.

The first supporting element 70 and the second supporting element 72 rotatably support the strap spool 2 on the housing 3. The housing 3 comprises a support portion 19 for the first supporting element 70 and the second supporting element 72 of the strap spool 2. The strap spool 2 is positioned within the support portion 19 and the strap spool 2 is rotatably supported on the support portion 19.

The assembly 1 comprises a retraction mechanism 7 for retracting the strap structure 4 around the rotatable strap spool 2. The retraction mechanism 7 can comprise a spring biased element where during unwinding the spring tension increases and any slack of the strap structure 4 is retracted to the strap spool 2. Typically, the retraction mechanism 7 is fixed to the rotatable strap spool and 3 and to the housing 3.

The retraction mechanism 7 is arranged between the retraction mechanism wall 71 and the cover wall 44. The housing 3 comprises further a retraction mechanism fixing portion 90. In this embodiment the housing 3 comprises a first housing outer wall 3a and a second housing outer wall 3b. The second housing outer wall 3b is arranged in the direction of X from the first housing outer wall 3a. X is a line which locates in a rotation axis of the rotatable strap spool 2. In other words X means a centre of rotation of the rotatable strap spool 2. The retraction mechanism fixing portion 90 is connected to the first housing outer wall 3a and the retraction mechanism fixing portion 90 extends between the first housing outer wall 3a and the second housing outer wall 3b. The retraction mechanism 7 is fixed to the housing 3 and to the rotatable strap spool 2. The retraction mechanism 7 is fixed to the retraction mechanism fixing portion 90 and to the strap bottom wall 43.

The second spool part 61 is arranged to fit with the first spool part 60. Typically, the second spool part 61 is attached to the first spool part 60 with a snap fit connector.

In one embodiment the assembly 1 further comprises a first lens 40. The first lens 40 is arranged between the light source 10 and the light receiving face 41 to focus light from light source 10 onto the light receiving face 41.

In one embodiment the first lens 40 is arranged to the housing 3. In other words, the first lens does not to rotate with the rotatable strap spool 2.

In an alternative embodiment the first lens 40 is arranged to the rotatable strap spool 2. In other words, the first lens 40 rotates with the rotatable strap spool 2.

The assembly further comprises a power source 12 electrically connected to the light source 10. The assembly comprises a light source connector 42 for connecting the power source 12 and the light source 10. The power source 12 is connected to the housing 3.

The power source 12 may comprise a rechargeable power source, electronics 13 for charging and a charging port 21. The charging port 21 and electronics 13 are connected to the housing 3.

In this embodiment the one or more elongated optical fibers 8 are arranged uniformly extend to the first cover axle end 47a. The one or more elongated optical fibers 8 are arranged on the cover wall 44 and one or more elongated optical fibers 8 extend from the first surface 43a of the strap bottom wall 43 to the cover axle 47 and inside the cover axle 47 to the first cover axle end 47a.

In this embodiment the cover wall 44, the first housing outer wall 3a, the second housing outer wall 3b, the retraction mechanism wall 71, the first strap guide wall 45 and the second strap guide wall 46 are arranged to transversal direction to the rotation axis of the rotatable strap spool X. The strap bottom wall 43 and the cover axle 47 are arranged to transversal direction to the first housing outer wall 3a.

In this embodiment the light receiving face 41 is arranged to the centre of rotation X of the rotatable strap spool 2.

FIG. 1b shows an alternative embodiment of the invention. In this embodiment the one or more elongated optical fibers 8 are arranged uniformly extend to the first cover axle end 47a. The one or more elongated optical fibers 8 are arranged to between the retraction mechanism 7 and the cover wall 44 and one or more elongated optical fibers 8 extend from the first surface 43a of the strap bottom wall 43 to the cover axle 47 and inside the cover axle 47 to the first cover axle end 47a. The other elements of the embodiment of FIG. 1b corresponds the embodiment of FIG. 1a.

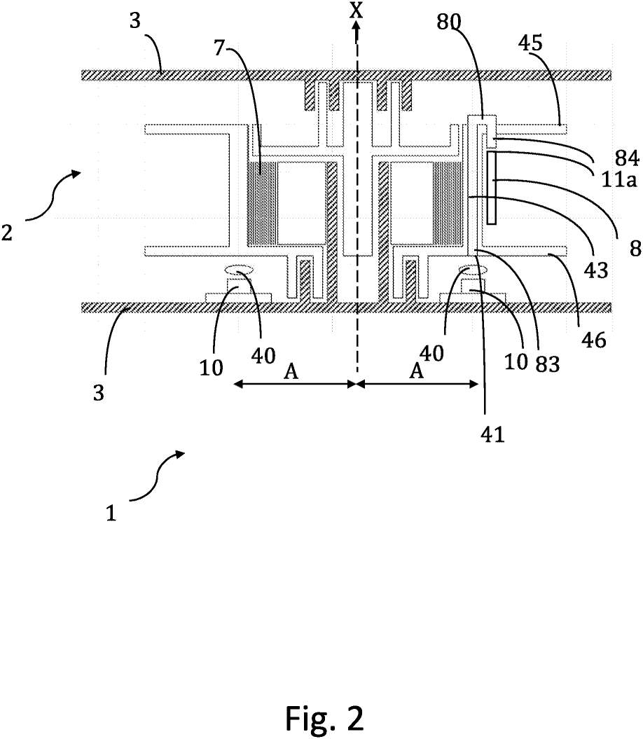

FIG. 2 shows an alternative embodiment of the invention. In this embodiment the assembly 1 comprises a light transmitting arrangement 80 having a first end 83 and a second end 84. The light transmitting arrangement 80 is arranged extend uniformly through the first strap guide wall 34 and in the strap bottom wall 43. In this embodiment the light receiving face 41 is arranged to the rotatable strap spool 2 at a distance of A from the centre of rotation X of the rotatable strap spool 2. In one embodiment the assembly 1 comprises two or more the light sources 10 connected to the housing 3 at the distance of A from the centre of rotation X of the rotatable strap spool 2. In alternative embodiment the light source 10 is circular and it radiates light to the light receiving face 4 in all positions of the light receiving face 4.

Alternatively, the one or more elongated optical fibers 8 are arranged to extend through the second strap guide wall 46 (not shown in the figure).

The other elements of the embodiment of FIG. 2 corresponds the embodiment of FIG. 1a.

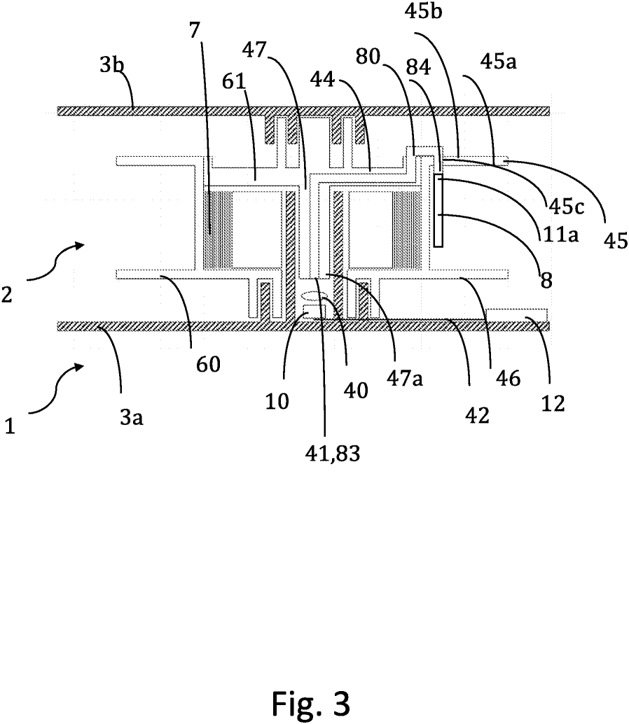

FIG. 3 shows an alternative embodiment of the invention. In this embodiment the assembly 1 comprises a light transmitting arrangement 80 having a first end 83 and a second end 84. The light transmitting arrangement 80 is connected to the rotatable strap spool 2. The first end 83 of the light transmitting arrangement 80 comprises the light receiving face 41, and the second end 84 of the light transmitting arrangement 80 illuminates the first end 11a of the one or more elongated optical fibers 8. In other words the light source 10 radiates light onto a face of the light transmitting arrangement 80 in the first end 83 of the light transmitting arrangement 80. The light transmitting arrangement 80 is arranged uniformly extend between the light receiving face 41 and the first end 11a of the one or more elongated optical fibers 8.

The first strap guide wall 45 having an inner first strap guide wall surface 45a and an outer first strap guide wall surface 45b. The light transmitting arrangement 80 is arranged to uniformly extend from the inner first strap guide wall surface 45a into the cover wall 44 and in the cover wall 44 into the cover axle 47 and in the cover axle 47 to the first cover axle end 47a.

In one embodiment the first strap guide wall 45 comprises a light transmitting arrangement opening 45c arranged to receive the second end 84 of the light transmitting arrangement 80.

In one embodiment the light transmitting arrangement 80 is fixed to the second spool part 61 of the rotatable spool 2.

In one embodiment the second end 84 of the light transmitting arrangement 80 is fixed to the first end 11a of the one or more elongated optical fibers 8.

In an alternative embodiment the second end 84 of the light transmitting arrangement 80 radiates light onto the first end 11a of the one or more elongated optical fibers 8.

The other elements of the embodiment of FIG. 3 corresponds the embodiment of FIG. 1a.

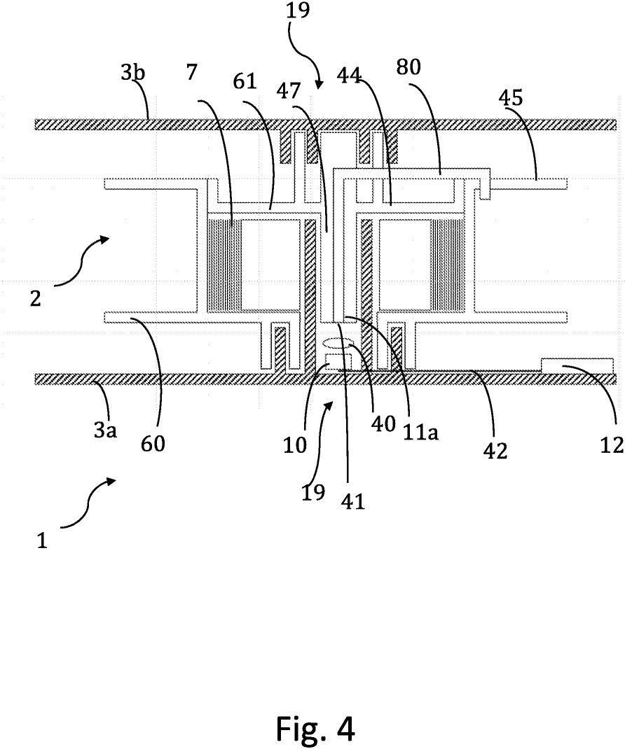

FIG. 4 shows an alternative embodiment of the invention. In this embodiment the assembly 1 comprises a light transmitting arrangement 80.

The light transmitting arrangement 80 is arranged to uniformly extend from the inner first strap guide wall surface 45a in a gap between the cover wall 44 and the second housing outer wall 3b into the cover axle 47 and in the cover axle 47 to the first cover axle end 47a.

In other words the light transmitting arrangement 80 is arranged between the cover wall 44 and the second housing outer wall 3b and in the cover axle 47.

The other elements of the embodiment of FIG. 4 corresponds the embodiment of FIG. 3.

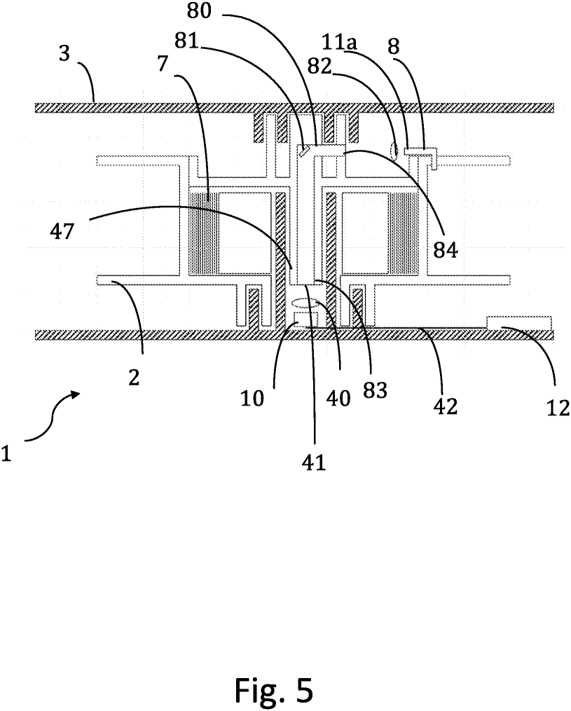

FIG. 5 shows an alternative embodiment of the invention. In this embodiment the assembly 1 comprises a light transmitting arrangement 80.

The light transmitting arrangement 80 is arranged to the cover axle 47. The second end 84 of the light transmitting arrangement 80 radiates light onto the first end 11a of the one or more elongated optical fibers 8. The assembly 1 may further comprise a second lens 82 to focus light from the light transmitting arrangement 80 to the first end 11a of the one or more elongated optical fibers 8.

In one embodiment the light transmitting arrangement 80 comprises a mirror element 81. The mirror element 81 is arranged to a corner of the light transmitting arrangement 80.

The other elements of the embodiment of FIG. 4 corresponds the embodiment of FIGS. 2 and 3.

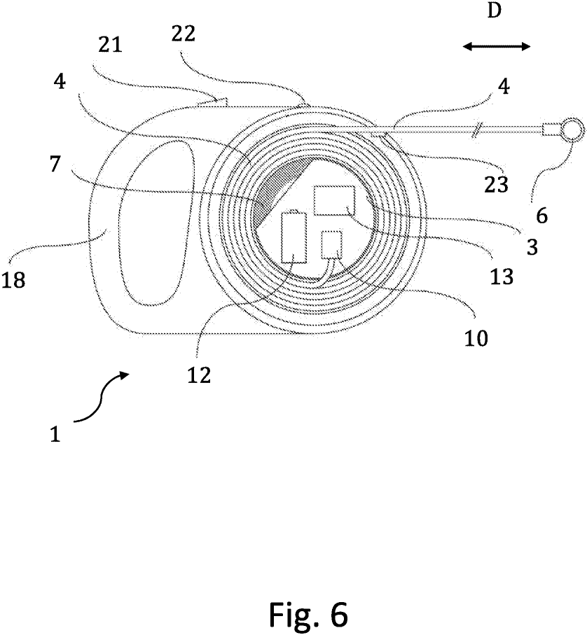

FIG. 6 shows an illuminated retractable strap assembly 1 comprising a housing 3 with a grip portion 18 having an opening for fingers. The assembly 1 is a handheld device. The assembly 1 shown in FIG. 6 is suitable for an animal tethering device, i.e. a retractable leash for animals.

The assembly 1 comprises a connector 6 arranged to the second end 5b of the light emitting strap structure 4. The connector 6 in the second end 5b of the strap structure 4 is releasably attachable to a pet collar or to a pet harness.

The assembly 1 comprises a rotatable strap spool 2. In the FIG. 6 the rotatable strap spool 2 is arranged inside a housing 3 comprising a grip portion 18. The housing 3 comprises a strap opening 23.

The strap structure 4 has a first end 5a which is fixed to the strap spool 2 and a second end 5b which has a connector 6 for connecting the strap structure 4. A retraction mechanism 7 retracts the strap structure 4 around the strap spool 2. The retraction mechanism 7 can comprise a spring biased element where during unwinding the spring tension increases and any slack of the strap structure 7 is retracted to the strap spool 2.

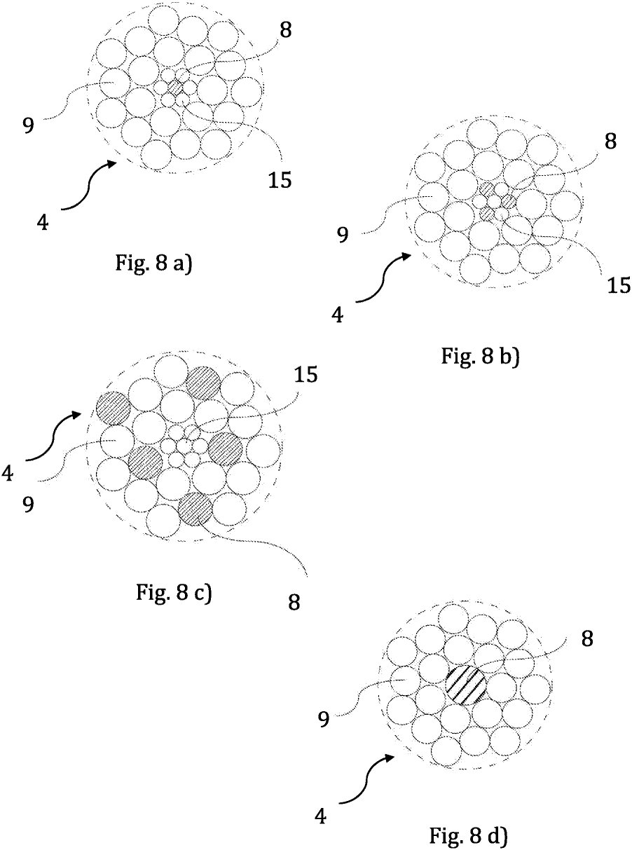

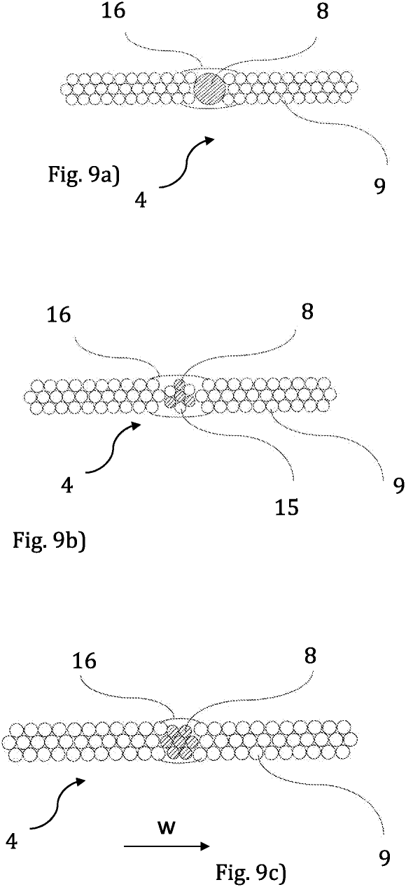

The strap structure 4 comprises one or more elongated optical fibers 8 for transmitting light between a first and a second end of the fibers. The strap structure can be any strap structure 4 described in connection with FIGS. 8a)-8d) and 9a)-9c).

The outer covering 9 allows at least part of the light originating from the one or more elongated optical fibers 8 to be transmitted through.

A light source 10 is arranged to radiate light directly or via the light transmitting arrangement 80 to the first end 11a of the elongated optical fiber 8 for generating light into the elongated optical fiber 8.

A power source 12 is electrically connected to the light source 10 for powering the light source 10 and comprises a rechargeable power source 12 comprising a charging port 21. The light source 10 can be a light-emitting diode or a laser diode, for instance. The assembly 1 comprises electronics 13 for charging the power source and for controlling the light source 10.

The shown assembly 1 comprises the light source 10, the power source 12, and electronics 13 mounted to the housing 3. In other words the light source 10, the power source 12, and electronics 13 do not rotate together with the strap spool 2.

This means that the light source 10 is stationary relative to the housing 3.

Further, this means that the light source 10 and the light emitting strap structure 4 arranged to and fixed to the rotatable strap spool 2 are separate parts.

The light source 10 may be fixedly mounted to the housing 3.

The assembly 1 comprises a button operated stop mechanism for stopping a rotation of the strap spool, and the button is provided on the outer surface of the housing.

The assembly 1 comprises an automatic twilight switch 22 for turning on and turning off the light source 10. The automatic twilight switch 22 is positioned to the upper part of the housing 3b. The automatic twilight switch 22 may also be operated manually to prevent undesired operation.

The assembly 1 comprises an automatic motion sensor 23 for detecting an unwinding and a retraction of the strap structure 4 where the unwinding is turning on and the retraction is turning off the light source 10. The motion sensor 23 can comprise a mechanical switch which is operated by an extension arranged to the strap structure 4 in a vicinity of the second end 5b of the strap structure 4. The motion sensor 23 can further comprise an optical sensor detecting a reflecting material arranged to the strap structure 4 in a vicinity of the second end 5b of the strap structure 4. The motion sensor 23 can also comprise an inductive sensor detecting a metal material arranged to the strap structure 4 in a vicinity of the second end 5b of the strap structure 4.

In one embodiment the assembly 1 comprises a dynamo arranged in connection to the rotatable strap spool 2 for charging the rechargeable power source 12.

Additionally, the assembly may comprise a position detector for changing the colour of the light source 10.

In the FIG. 6 is described a rechargeable power source 12, a dynamo 24, a stop mechanism 21, an automatic twilight switch 22 and an automatic motion sensor 23. It is to be understood that it is not necessary for an illuminated retractable strap assembly 1 to comprise any of them but the illuminated retractable strap assembly 1 can comprise any of them or any combination of them or all of them.

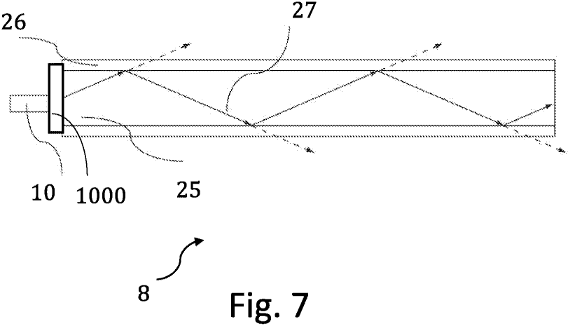

FIG. 7 shows an elongated optical fiber 8. The elongated optical fiber 8 is side emitting, i.e. a side glow optical fiber. The elongated optical fiber 8 comprises a core 25 and a cladding 26. A light source 10 is arranged to radiate light directly or via the light transmitting arrangement 80 to the first end 11a of the elongated optical fiber 8 for generating light into the elongated optical fiber 8. A light beam 27 travels in the direction of the core 25 and part of the light is escaping from the side of the elongated optical fiber 8 through the cladding 26. Part of the light is escaping from the second end 11b of the elongated optical fiber 8 which phenomina is called an end glow. The side emitting, i.e. the side glow elongated optical fiber can comprise a plastic optical fiber where the core material is PMMA and the cladding material comprises fluorinated polymers, for instance. FIG. 7 shows an embodiment where the assembly 1 comprises an optic rotary connector 1000 for transmitting light from the housing 3 to the rotatable strap spool 2. The optic rotary connector 1000 is arranged between the light source 10 and the light receiving face 41. The optic rotary connector 1000 may be connected directly to the light source 10 and to the light transmitting arrangement 80.

In an alternative embodiment, the assembly 1 comprises an additional optic fiber between the light source 10 and the optic rotary connector 1000 (not shown in the figure). The optic rotary connector 1000 may be connected to the additional optic fiber and to the light transmitting arrangement 80.

FIGS. 8a), b), c) and d) show top views in cross-section showing some strap structure 4 examples. The strap structure 4 shown is substantially round in cross-section. The round shape of the strap structure 4 is indicated with a dotted line. The shown strap structures 4 comprise one or more elongated optical fibers 8, elongated flexible strengthening fibers 15 and an outer covering 9, which comprises elongated strands. The elongated strands run in the lengthwise direction of the strap structure 4.

FIG. 8a) shows a strap structure 4 where the structure 4 comprises elongated flexible strengthening fibers 15 arranged to surround the one or more elongated optical fibers 8. The one or more elongated optical fibers 8 are arranged in the middle of the strap structure 4. The outer covering 9 is arranged to surround the elongated flexible strengthening fibers 15, where the elongated strands run in the lengthwise direction of the strap structure 4.

FIG. 8b) shows a strap structure 4 where the one or more elongated optical fibers 8 and the elongated flexible strengthening fibers 15 are arranged in a free order to the middle part of the strap structure 4. The elongated flexible strengthening fibers 15 and the one or more elongated optical fibers 8 are arranged to form a bundle and the outer covering 9 is arranged to surround the bundle.

FIG. 8c) shows a strap structure 4 where the elongated flexible strengthening fibers 15 are arranged in the middle of the strap structure 4. The one or more elongated optical fibers 8 and the elongated strands of the outer covering 9 are arranged in a free order to surround the elongated flexible strengthening fibers 15. In the shown strap structure 4, at least one of the one or more elongated optical fibers 8 is arranged to form a part of the outer surface of the strap structure 4.

FIG. 8d) shows a strap structure 4 where the outer covering 9 is arranged to surround the one or more elongated optical fibers 8. The outer covering 9 stretches less in the length direction than the elongated optical fiber 8. The outer covering 9 is transparent or translucent.

FIGS. 9a), 9b) and 9c) show a top view in cross-section showing a strap structure 4. The strap structure 4 shown has a substantially flat rectangular shape. The substantially flat rectangular shape is made by the outer covering 9, which comprises elongated strands. In the width direction w of the strap structure 4 the one or more elongated optical fibers 8 are arranged to the central part of the strap structure 4. The both sides of the outer covering 9 extending in the width direction w of the strap structure 4 are connected with a connection material 16. The outer covering 9 may comprise a braided structure.

FIG. 9a) shows a strap structure 4 where a one elongated optical fiber 8 is arranged to the central part of the strap structure 4.

FIG. 9b) shows a strap structure 4 where the more elongated optical fibers 8 and the elongated flexible strengthening fibers 15 are arranged in a free order to the central part of the strap structure 4.

FIG. 3) shows a strap structure 4 where a bunch of elongated optical fibers 8 is arranged to the central part of the strap structure 4.

The elongated covering strands of the outer covering 9 or part of them in FIGS. 8a)-8d) and 9a)-9c) can comprise reflective material or comprise a reflective surface to further intensify the illumination.

The present invention provides a method for illuminating a strap structure in which an illumination is carried out with a strap assembly comprising a housing 3, a rotatable strap spool 2 connected rotatably to the housing 3, a light emitting strap structure 4 arranged to and fixed to the rotatable strap spool 2. The assembly 1 further comprises a light source connected to the housing 3.

The light source 10 is stationary relative to the housing 3.

The method comprises:
-radiating light from the light source 10 to the rotatable strap spool 2 to illuminate the first end 5a of the light emitting strap structure 4 arranged to the rotatable strap spool 2.

The invention has been described above with reference to the examples shown in the figures. However, the invention is in no way restricted to the above examples but may vary within the scope of the claims.

1-15. (canceled)

16. An illuminated strap assembly, the assembly comprising a housing, a rotatable strap spool connected rotatably to the housing, a light emitting strap structure arranged to and fixed to the rotatable strap spool, the light emitting strap structure comprising a first end and a second end, wherein the assembly comprises:
a light source connected to the housing
the light source is arranged to radiate light towards the rotatable strap spool and to illuminate the first end of the light emitting strap structure arranged to the rotatable strap spool.

17. The illuminated strap assembly according to claim 16, wherein the strap structure comprises:
one or more elongated optical fibers having a first end and a second end for transmitting light between the first end and the second end, and an outer covering,
the outer covering is arranged to pass at least part of the light originating from the one or more elongated optical fibers to be transmitted through.

18. The illuminated strap assembly according to claim 16, wherein:
the assembly comprises a light receiving face arranged to the rotatable strap spool,
the light receiving face is arranged to face towards the light source,
the light source is arranged to radiate light onto the light receiving face.

19. The illuminated strap assembly according to claim 18, wherein:
the first end of the one or more elongated optical fibers comprises the light receiving face.

20. The illuminated strap assembly according to claim 18, wherein :
the assembly comprises a light transmitting arrangement having a first end and a second end,
the light transmitting arrangement is connected to the rotatable strap spool,
the first end of the light transmitting arrangement comprises the light receiving face, and
the second end of the light transmitting arrangement illuminates the first end of the one or more elongated optical fibers.

21. The illuminated strap assembly according to claim 18, wherein the assembly comprises:
a first lens for focusing light from light source onto the light receiving face, the first lens is arranged between the light source and the light receiving face; or
an optic rotary connector for transmitting light from the housing to the rotatable strap spool.

22. The illuminated strap assembly according to claim 18, wherein the rotatable strap spool having a centre of rotation (X), and:
the light receiving face is arranged to the centre of rotation (X) of the rotatable strap spool; or
the light receiving face is arranged to rotatable strap spool at a distance of (A) from the centre of rotation (X) of the rotatable strap spool.

23. The illuminated strap assembly according to claim 22, wherein:
the assembly comprises two or more the light sources connected to the housing at the distance of (A) from the centre of rotation (X) of the rotatable strap spool.

24. The illuminated strap assembly according to claim 16, wherein:
the light source comprises a light-emitting diode or a laser diode.

25. The illuminated strap assembly according to claim 16, wherein the assembly comprises a connector arranged to the second end of the light emitting strap structure.

26. The illuminated strap assembly according to claim 16, wherein the assembly comprises a retraction mechanism for retracting the strap structure around the rotatable strap spool.

27. The illuminated strap assembly according to claim 16, wherein:
the assembly comprises a power source electrically connected to the light source, and
the power source is connected to the housing.

28. The illuminated strap assembly according to claim 27, wherein the assembly comprises:
the power source comprises a rechargeable power source,
the rechargeable power source comprises a charging port,
electronics for charging, and
the charging port and electronics are connected to the housing; or
the power source comprises a rechargeable power source,
the rechargeable power source comprises a wireless charging component,
electronics for charging, and
the wireless charging component and electronics are connected to the housing.

29. The illuminated strap assembly according to claim 16, wherein:
a housing comprising a grip portion and a support portion for the strap spool,
the strap spool is positioned within the support portion and the strap spool is rotatably supported on the support portion.

30. A method for illuminating a strap structure, the method is carried out with a strap assembly comprising a housing, a rotatable strap spool connected rotatably to the housing, a light emitting strap structure arranged to and fixed to the rotatable strap spool, wherein the assembly further comprises:
a light source connected to the housing,
the method comprises:
radiating light from the light source to the rotatable strap spool to illuminate the first end of the light emitting strap structure arranged to the rotatable strap spool.
